(19) United States
(12) Patent Application Publication
(10) Pub. No.: US 2021/0171360 A1
(43) Pub. Date: Jun. 10, 2021

(54) Liquid Treatment Device, Method of Manufacturing It and Liquid Treatment System

(71) Applicant: BRITA GMBH, Taunussstein (DE)

(72) Inventors: Marcus HORN, Wiesbaden (DE); Thomas NAGEL, Weinbach (DE); Simon FLOREN, Waldbrunn (DE); Maria FESTNER, Wiesbaden (DE)

(21) Appl. No.: 16/477,012

(22) PCT Filed: Nov. 14, 2017
(86) PCT No.: PCT/EP2017/001327

§ 371 Date: Jul. 10, 2019

(30) Foreign Application Priority Data
Nov. 14, 2016 (EP) 16198653.4

(51) Int. Cl. C02F 1/00; C02F 1/42

(52) U.S. Cl. CPC C02F 1/003; C02F 1/42; C02F 2201/006; C02F 2307/04; C02F 2201/004

(57) ABSTRACT

A liquid treatment device includes a container section defining a container for holding liquid to be treated. The container section includes at least part of a body, the body including at least one wall forming at least a bottom of the container. At least one first liquid-permeable window through the wall forming the bottom of the container is provided. The device also includes a liquid treatment section, including a cavity surrounded by a cavity side wall forming at least one second liquid-permeable window for treating liquid passing through it. The cavity side wall is sealingly joined to a liquid-impermeable wall section along the circumference of the cavity side wall and around a liquid path through the cavity and the first liquid-permeable windows at an end of the cavity side wall proximal to the at least one first liquid-permeable windows. The liquid-impermeable wall section is an inseparable part of the body.

### FIELD OF THE INVENTION

The invention relates to a liquid treatment device, including: a container section defining a container for holding liquid to be treated, the container section including at least part of a body, the body including at least one wall forming at least a bottom of the container, wherein at least one first liquid-permeable window through the wall forming the bottom of the container is provided; and a liquid treatment section, including a cavity surrounded by a cavity side wall forming at least one second liquid-permeable window for treating liquid passing through it, wherein the cavity side wall is sealingly joined to a liquid-impermeable wall section along the circumference of the cavity side wall and around a liquid path through the cavity and the first liquid-permeable windows at an end of the cavity side wall proximal to the at least one first liquid-permeable windows.

The invention also relates to a liquid treatment system.

The invention also relates to a method of manufacturing the liquid treatment device.

### BACKGROUND OF THE INVENTION

WO 2015/006561 A1 discloses a filter for gravity-fed applications, and describes that a common application is directed to a batch treatment and filtration device where water is filtered, treated and stored in a container. These self-contained systems typically have upper and lower chambers separated by a filter cartridge, the most popular styles being the pour-through carafe or the refrigerator water tank. Such systems include an upper reservoir for receiving unfiltered water, a lower reservoir for receiving and storing filtered water and a filter, usually of granular activated carbon or pleated filter sheets, with at least one inlet at the filter housing top and at least one outlet at the filter housing bottom, which allows water to flow from the upper reservoir to the lower reservoir. The specific embodiment disclosed in WO 2015/006561 A1 has a filter housing including a top cap circumferentially secured or attached to a filter media top end cap, which attaches to filter media. The filter media top end cap is generally fixed to the filter media by a sealant or friction fit. The filter media is shown as pleated fibre sheets. The filter may further include a side housing shell or outer shroud. The filtering media is terminated circumferentially to a bottom cap. The filter housing is designed so that fluid flows from ingress ports on the top cap and filter media top cap through a hollow centre of the filter media and radially outwards towards side apertures.

It is clear from the description and drawings of WO 2015/006561 A1 that the filter media top end cap defines a circumferential sealing rim configured to be brought into sealing engagement with a cartridge seat surface defined in an aperture in the bottom wall of the upper reservoir, as is common with such gravity-driven systems. If the filter media is to perform as an antimicrobial filter, then this relies on proper insertion of the filter housing into the cartridge seat by a user.

### SUMMARY OF THE INVENTION

It is an object of the invention to provide a liquid treatment device, liquid treatment system and method of the types defined above in the opening paragraphs that are relatively effective in preventing contamination of the treated liquid, in particular by mixing with untreated liquid from the container.

This object is achieved according to a first aspect by the liquid treatment device according to the invention, which is characterised in that the liquid-impermeable wall section is an inseparable part of the body.

The liquid treatment device includes a container section defining a container for holding liquid to be treated. This container section functions rather like a hopper or funnel of a conventional gravity-driven system, or like a tank of a system provided with a suction pump. Thus, the container may be a component for a gravity-driven liquid treatment system. Examples include jug filters, but also gravity-driven water filter and dispensing system provided with a dispensing valve and configured for placement on a worktop or in a refrigerator.

The container section includes a body, the body including at least one wall forming at least a bottom of the container. The set of walls making up the body includes at least one liquid-impermeable wall that together form at least the bottom and sides of the container. Depending on the shape of the container, it may be possible to make out a bottom wall and side wall. In other embodiments, the side wall may slope inwards to define also the bottom of the container. These walls bound the container interior in which the liquid to be treated is held, in use. The liquid will generally exit through the at least one first liquid-permeable window through the wall forming the bottom of the container. This may be an aperture, which may, in use, be open or occupied by a barrier provided with liquid-permeable windows. Generally, the at least one first liquid-permeable window will provide a liquid path between the container interior and the cavity of the liquid treatment section. Embodiments are conceivable in which the liquid treatment section is located inside the container interior, so that the liquid to be treated flows through the cavity side wall into the cavity and out of the liquid treatment device through the at least one first liquid-permeable window. This would be a useful embodiment for a liquid treatment system including a suction pump for moving treated liquid.

As mentioned, the cavity is surrounded, not necessarily bounded, by a cavity side wall forming at least one liquid-permeable window for treating liquid passing through it. The treatment will generally include at least some form of filtration, which may be chemical, mechanical, (electro-)physical or a combination thereof, as will be explained. Because the cavity side wall is sealingly joined to a liquid-impermeable wall section along the circumference of the cavity side wall and around a liquid path between the cavity and the first liquid-permeable windows at an end of the cavity side wall proximal to the at least one first liquid-permeable windows, any liquid that passes through the at least one first liquid-permeable windows must also pass through the at least one second liquid-permeable windows. It cannot bypass the cavity side wall at the edge proximal to the at least one first liquid-permeable windows. Because the liquid-impermeable wall section is an inseparable part of the body, there is no need for correct placement of a cartridge comprising the liquid treatment section in order to prevent a bypass path between the container interior and the exterior of the device from opening up. Thus, untreated liquid cannot mix with treated liquid.

The liquid-impermeable wall section is an inseparable part of the body that further includes at least the liquid-impermeable walls forming the bottom of the container. This means that the wall section and wall or walls are only separable in an irreversible manner, e.g. by cutting or tearing them apart, or by melting material of which they are made or by which they are joined. At the end of the useful life of the liquid treatment media included in the cavity side wall, the entire liquid treatment device is replaced.

In an embodiment, any seams in transitions between the liquid-impermeable wall section and the at least one wall forming at least the bottom of the container are between parts of the body joined by bonding.

This provides relatively good sealing between the bottom wall of the container and the cavity side wall end without the need for separate sealing elements. The liquid-impermeable wall section is either an integral part of the wall or walls forming the bottom of the container, or it is joined directly or indirectly thereto by bonding. In the former case, the transition is seamless. In the latter case, the bonding may be adhesive bonding or welding, for example. More generally it includes any form of joining in which a positive material joint is formed, meaning that the material of the joined parts, and optionally an adhesive or filler material, is coalesced.

In a particular embodiment, the liquid-impermeable wall section adjoins a section of a wall forming the bottom of the container.

This reduces the number of parts. There is no further interconnecting part. The liquid-impermeable wall section may in particular be an integral section of a wall forming the bottom of the container, i.e. made in one piece with it.

In an embodiment, the liquid treatment section includes an end wall, sealingly joined to the cavity side wall along the circumference of the cavity side wall at an end of the cavity side wall opposite the end joined to the liquid-impermeable wall section, and at least a section of the end wall inwards of where it is joined to the cavity side wall is liquid-impermeable.

The end wall closes off the cavity at an end opposite to the end at which the first liquid-permeable window(s) is or are provided. Liquid cannot pass through this end wall, so that a relatively high pressure differential is established across the cavity side wall. The cavity side wall is thus relatively effective in treating the liquid.

In an embodiment, the at least one first liquid-impermeable window defines at least part of a flow path between an interior of the container and the cavity.

In this embodiment, the liquid treatment section is axially adjacent the container section, rather than inside it. The liquid flows from the interior of the container into the cavity. From there, it flows radially outwards, through the cavity side wall. Compared to radially inwardly directed flow, the cavity side wall need not be strengthened to withstand radial compression.

In an embodiment, the cavity side wall includes at least one layer of sheet material, e.g. pleated sheet material, functioning as at least one of the at least one second liquid-permeable windows.

The cavity side wall may thus include a single sheet closed on itself around the cavity or a sandwich of sheets arranged in this manner. In the latter case, the sheets may have different properties. Granular matter, in particular in powder form, may be arranged within or between sheets. This matter may include at least one liquid treatment medium, e.g. an adsorbent such as activated carbon. The sheet may be a porous membrane or a sheet of textile, woven or non-woven. The cavity side wall is relatively easy to form when made of sheet material. It can moreover be relatively thin, thus keeping the resistance to flow relatively low. When pleated, it presents a relatively large surface area. It is noted that the layer or layers of sheet material may be supported by a self-supporting frame on either or both sides. Additionally or alternatively, strengthening ribs may be bonded to it along edges.

In a variant of this embodiment, at least one of the at least one layers of sheet material is a sheet of textile.

Textile has larger interstices (between the fibres) than e.g. a porous membrane, whilst still being effective in treating, in particular filtering liquids.

In a particular variant, at least one layer of sheet material is a sheet of functionalised textile.

This means that the fibres are chemically or physically activated to provide adsorbent properties. As a result, relatively small particles, e.g. microbes, can be filtered. The fibres may be electroactive or charge-modified fibres, e.g. including sites having an electrokinetic potential in the range of 20-75 mV, e.g. 40-70 mV. The fibres may be made of or coated with a metal oxide, e.g. aluminium oxide, aluminium hydroxide or zirconium oxide. A particular example is boehmite (γ-AlO(OH)).

An embodiment of the liquid treatment device includes a further liquid treatment part arranged between an interior of the container and the cavity side wall in a direction of flow.

The further liquid treatment part may be arranged to carry out a mechanical, physical or chemical treatment, in particular removing certain components from the liquid. In this embodiment, the cavity side wall may be protected or at least given an enhanced useful lifetime. Also, the further liquid treatment part may be arranged to treat liquid in a diffusive process, e.g. adsorption, in particular ion exchange. Relatively long contact times can be provided for in the further liquid treatment part. This would not be practical if the same treatment were to be carried out by a liquid treatment medium in the cavity side wall, because the rate of flow would have to be quite low. The further liquid treatment part, by contrast, can have a relatively large depth.

In a variant of this embodiment, at least part of the further liquid treatment part is arranged in the cavity.

This embodiment makes relatively good use of the available space in the liquid treatment device.

In a variant of the embodiment that includes a further liquid treatment part arranged between the container interior and the cavity side wall in a direction of flow, the further liquid treatment part is included in a replaceable liquid treatment cartridge.

The further liquid treatment part can thus include a liquid treatment medium having a relatively short useful lifespan compared with the liquid treatment medium of the cavity side wall. In turn, it enhances the useful lifespan of the liquid treatment medium of the cavity side wall by carrying out a pre-treatment of the liquid. In general, the cavity side wall will carry out the critical liquid treatment such as antimicrobial filtering. Because the further liquid treatment part is arranged between the container interior and the cavity side wall in a direction of flow, any bypass of the further liquid treatment part will not adversely affect such critical treatment.

In an embodiment, the at least one first liquid-permeable window includes an aperture bordered along a circumference by a sealing surface for engaging a sealing rim of a replaceable liquid treatment cartridge, e.g. a sealing surface tapering inwards in a direction of the cavity.

Thus, this embodiment provides a cartridge seat for a replaceable liquid treatment cartridge including the further liquid treatment part. Such a cartridge may include a housing with liquid-impermeable walls in which at least one liquid inlet and at least one liquid outlet are provided. Alternatively or additionally, the cartridge may include a porous liquid-permeable body, e.g. made of thermally bonded granular or fibrous matter, or a combination thereof, which may include matter functioning as a liquid treatment medium. A tapering sealing surface facilitates placement of the cartridge and the formation of a relatively good seal. Where the aperture is circular, the sealing surface is conical. Otherwise it is geometrically more accurately described as quadric.

In an embodiment of the liquid treatment device, at least the cavity side wall is joined to the liquid-impermeable wall section to form an assembly, and the assembly is joined to a remainder of the body.

This embodiment facilitates handling during manufacturing, because the part of the body included in the container section will generally be relatively large. It is well-suited to being formed by moulding, e.g. injection-moulding. It will not be in the way when the cavity side wall is sealingly joined to the liquid-impermeable wall section and optionally an end wall at an opposite axial end.

In an embodiment of the liquid treatment device, a side wall of the container section is provided with a laterally protruding ridge at a mouth of the container section on an opposite side of the container section to the liquid treatment section.

This allows the container section and thus the liquid treatment device to be suspended within a further container, e.g. a jug, carafe or dispenser tank. The laterally protruding ridge can be placed on a rim of a mouth of such a further container or a ledge on an inside of a side wall of such a container near its mouth.

In an embodiment of the liquid treatment device, at least liquid-impermeable walls of the body are self-supporting.

In this embodiment, the container section in particular cannot collapse. This distinguishes this embodiment from liquid treatment devices comprising a bladder with a liquid treatment device sealed in an outlet thereof. The embodiment is relatively easy to mount in a liquid treatment system.

According to another aspect, the liquid treatment system according to the invention includes a container for collecting treated liquid and a liquid treatment device according to any one of the preceding claims, suspendable above a base of the container for collecting treated liquid.

In an embodiment, the liquid treatment device is suspendable within the container for collecting treated liquid.

This allows a lid of the container for collecting treated liquid also to cover the container interior. The liquid treatment device need not have its own lid.

In an embodiment therefore, the liquid treatment system includes a separate lid for covering an interior of the container for holding liquid to be treated, e.g. a lid with a fill opening.

In an embodiment of the liquid treatment system, the at least one first liquid-permeable window includes an aperture bordered along a circumference by a sealing surface, e.g. a sealing surface tapering inwards in a direction of the cavity, and the system further includes a replaceable liquid treatment cartridge provided with a circumferential sealing rim for sealingly engaging the sealing surface.

Liquid is thus forced to flow through the cartridge on its way into the cavity. The cartridge is effective to carry out pre-treatment of the liquid, thus complementing the treatment in the cavity side wall. The useful lifespan of the liquid treatment medium of the cavity side wall may thereby be extended, if only by mechanical pre-filtering.

In a variant of this embodiment, the replaceable liquid treatment cartridge includes a housing, in which a liquid treatment part is arranged, the housing including at least one liquid-permeable inlet window and at least one liquid-permeable outlet window, on opposite respective sides of the sealing rim in flow direction.

Thus, liquid is forced to enter the housing, which defines at least one chamber in which a liquid treatment medium may be arranged. This may in particular include a bed of granular matter. The matter need not be bound in this embodiment, so that the surface area of the liquid treatment medium or media is increased. It may therefore in particular include at least one liquid treatment medium for the treatment of liquid in a diffusive process, e.g. adsorption, more particularly ion exchange.

According to another aspect of the invention, a method of manufacturing a liquid treatment device according to the invention includes forming a body including at least one of the walls of the container section and sealingly joining at least one of the liquid-impermeable wall section and the cavity side wall to the body.

In an embodiment in which the handling of parts during manufacturing is facilitated, at least the cavity side wall is joined to the liquid-impermeable wall section to form an assembly, and the assembly is subsequently joined to a remainder of the body.

The assembly may include a further end wall to which the cavity side wall is sealingly joined along the circumference of the cavity side wall at an end of the cavity side wall opposite the end at which it is joined to the liquid-impermeable wall section.

### BRIEF DESCRIPTION OF THE DRAWINGS

The invention will be explained in further detail with reference to the accompanying drawings, in which:

FIG. 1 is a side view of a liquid treatment system;

FIG. 2 is a cross-sectional view of part of a first replaceable liquid treatment device for the liquid treatment system of FIG. 1;

FIG. 3 is a cross-sectional view of part of a second replaceable liquid treatment device for the liquid treatment system of FIG. 1; and

FIG. 4 is a cross-sectional view of part of a third replaceable liquid treatment device for the liquid treatment system of FIG. 1, wherein the liquid treatment system further includes a separate replaceable liquid treatment cartridge.

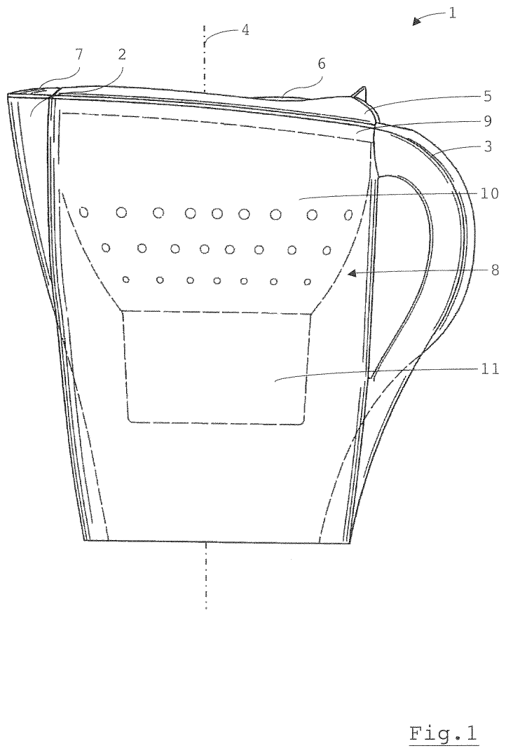

### DETAILED DESCRIPTION OF THE INVENTION

A liquid treatment system for the treatment of aqueous liquids such as mains drinking water includes a jug 1 as an example of a container for collecting treated liquid. The jug 1 is provided with a pouring spout 2 and a handle 3. The jug 1 is open at an end opposite a base. The jug 1 has an elongated cross-sectional shape for cross-sections perpendicular to an upright axis 4 that is oriented substantially vertically when the jug 1 is stood on its base.

The open end of the jug 1 is closed by a lid 5 including a fill opening closed by a pivotable closure element 6. A pivotable spout cover 7 is part of the lid 5 and closes the pouring spout 2 when the jug 1 is stood on its base.

A liquid treatment device in the form of a funnel 8 is suspended within the jug 1. To this end, an exterior ridge 9 at an, in use, upper end of the funnel 8 is supported by a ledge formed on an interior surface of a side wall of the jug 1. The ledge and ridge 9 need not extend all the way around the circumference of the funnel 8. The ledge is at such a level that the funnel 8 is suspended completely within the jug 1. The lid 5 is supported by the jug 1 and covers a mouth of the funnel 8.

It is possible to define an upright axis of the funnel 8, in this example aligned with the jug axis 4 when the funnel 8 is suspended in the jug 1. Seen in axial direction, the funnel 8 comprises two adjacent sections. One section 10 defines a container for holding liquid to be treated. Another section 11 defines a cavity through which liquid is forced to flow and in which at least one liquid treatment medium may be arranged.

The container section 10 includes a side wall separating an interior of the container from the environment. This side wall is closed on itself about the funnel axis. An edge at an in use upper end of the funnel 8 defines a mouth of the funnel 8. The exterior ridge 9 is provided at this end. The side wall slopes inwards towards the liquid treatment section 11 defining the cavity, so that the section 10 defining the container for holding liquid to be treated has no clearly defined bottom wall. In a different embodiment (not shown), there may be such a wall transitioning into the side wall at a clearly defined edge.

Liquid-impermeable walls of the funnel 8 will generally be made of plastic, e.g. styrene-acrylonitrile (SAN), polyethylene polypropylene, styrene maleic anhydride (SMA) or polystyrene. The latter-mentioned two materials, in particular SMA, provide a lasting relatively glossy finish without extensive use of additives. Where the walls are joined, they are bonded, so that a positive material joint is formed. This means that the material of the walls and that of an optional adhesive or filler material is coalesced. The walls may be joined by welding, soldering or adhesive bonding. The walls are self-supporting, maintaining a substantially stable shape without any need for external reinforcement.

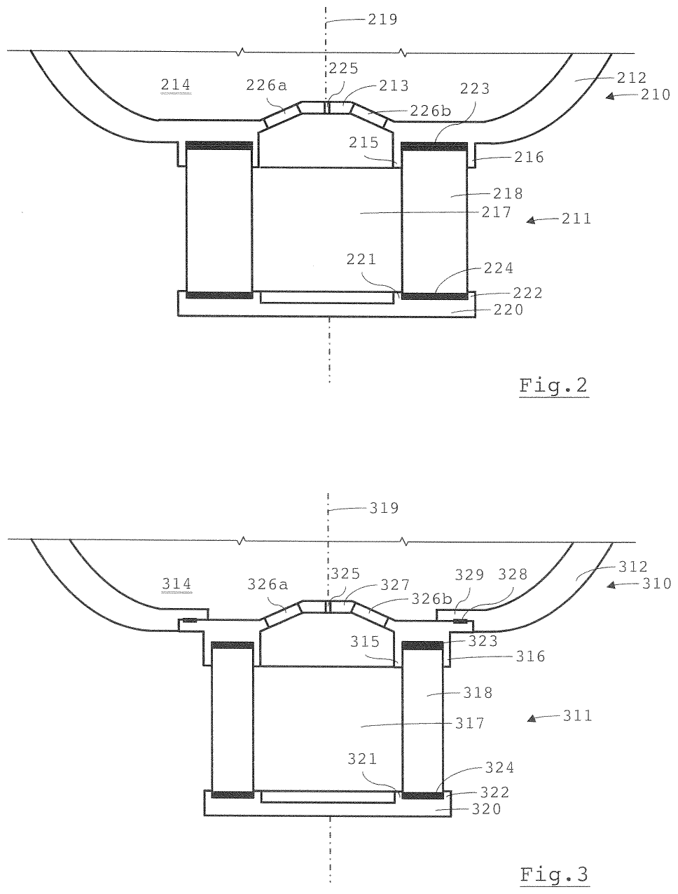

A first implementation (FIG. 2) of the funnel 8 includes a container section 210 and a liquid treatment section 211. The liquid-impermeable funnel side wall 212 transitions seamlessly into a separating wall section 213, so that they are integral parts of the same body, which is made in one piece. The body may be obtained by injection-moulding, for example. In this way, it is impossible for liquid to flow out of a container interior 214 without passing into the liquid treatment section 211.

The body also includes inner and outer annular depending wall sections 215,216. These are likewise made in one piece with the wall forming at least the bottom of the container section 210.

The liquid treatment section 211 includes a cavity 217, which in this embodiment is empty.

A liquid-permeable cavity side wall 218 is closed on itself about an upright funnel axis 219. The cavity side wall 218 is shaped to provide the cavity 217 with an essentially circular cross-section (with the cross-sectional plane perpendicular to the funnel axis 219). The cross-section may be elongated in an alternative embodiment.

The liquid-permeable cavity side wall 218 includes at least one layer of sheet material. At least one such layer of sheet material may be in the form of a membrane or a woven or non-woven textile arranged to filter microbes. The textile fibres may be functionalised to provide them with chemical or electrophysical properties that enable the sheet material made of these fibres to filter out microbes. For example, the textile material may include silver or a silver salt or compound. It may include electroactive or charge-modified fibres. Such fibres are effective to retain microorganisms through electroadsorption. Material including such fibres may include sites having an electrokinetic potential in the range of 20-75 mV, e.g. 40-70 mV, for example. The fibres of the textile material may include fibres made of or provided with a coating including a metal oxide, e.g. aluminium oxide, aluminium hydroxide or zirconium oxide. A particular example is boehmite (γ-AlO(OH)). The fibres may have a diameter in the range of 2-1000 nm, e.g. in the range of 2-100 nm. They may have a ratio of length to diameter of between 1 and 5, for example.

Other fibres of one or more layers of sheet material of the cavity side wall 218 may be cellulose fibres, glass fibres, viscose fibres, polyester fibres, polyethylene fibres, polypropylene fibres, cotton fibres or a mixture thereof, optionally with a binder.

The cavity side wall 218 may include a layer of sheet material comprising activated carbon fibres. Such sheet material is obtainable by heat treatment of a non-woven textile material made of organic fibres to carbonise them, followed by an activation step. Alternatively, a layer of sheet material may include powdered activated carbon, which need not be bound, e.g. powdered activated carbon having a mean particle size (d₅₀) in the range of 2-10 μm.

Specific examples of suitable sheet material are provided in WO 03/000407 A1, for example. Compared with a semi-permeable membrane, variants with a functionalised woven or non-woven textile sheet material have a lower resistance to flow whilst still being capable of filtering out microbes.

Although not shown, a liquid-permeable support tube may be arranged radially inwards of the sheet material. The sheet material may alternatively be arranged on a self-supporting frame. A screen (not shown) arranged radially outwards of the sheet material may protect it in one embodiment.

Where the sheet material includes a semi-permeable membrane, it may be made of cellulose acetate, polyethersulfone, polyamide, polytetrafluoroethylene, or polycarbonate, for example. The membrane may have porous voids with a mean pore size of between 0.05 and 5 μm, for example, e.g. below 2 μm.

A liquid-impermeable axial end wall 220 is a separate component, shaped to have an inner and outer annular ridge 221,222 directed towards the container section 210.

An upper bond 223 sealingly joins the cavity side wall 218 to the container section 210 at one axial end. A lower bond 224 sealingly joins the cavity side wall 218 to the axial end wall 220. In this way, it is impossible for liquid to leave the liquid treatment section 211 without being treated on its way through the cavity side wall 218. The bonds 223,224 may be made with a potting compound such as polyurethane or with a hot-melt adhesive, for example.

Viewed from the cavity 217, the separating wall section 213 is concave. It is substantially dome-shaped. A venting aperture 225 is provided at the apex of the dome. Slits 226a,b form liquid-permeable inlet windows allowing liquid to pass from a container interior 214 to the cavity 217. These slits 226a,b extend substantially to a base of the dome.

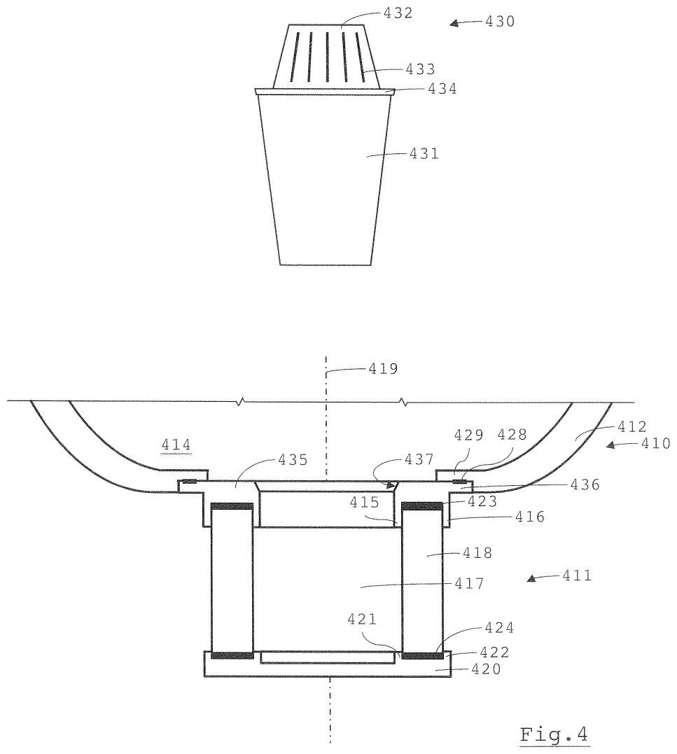

A second implementation (FIG. 3) of the funnel 8 also includes a container section 310 and a liquid treatment section 311. In this variant, the liquid treatment section 311 is first manufactured separately from the container section 310, whereupon the two sections are assembled such as to become inseparable.

The liquid treatment section 311 includes an assembly of a liquid-permeable cavity side wall 318 and a liquid-impermeable axial end wall 320. The latter is shaped to have an inner and outer annular ridge 321,322 directed towards the container section 310. The cavity side wall 318 is of the same type as the cavity side wall 218 of the first implementation of the funnel 8 described above. It is similarly joined to the axial end wall 320 by a bond 324. The cavity side wall 318 and the axial end wall 320 form a beaker-shaped component.

The cavity side wall 318 is sealingly joined to a cap-shaped component 327 at its opposite axial end by a bond 323. To this end, the cap-shaped component includes integral inner and outer annular depending wall sections 315,316. The cap-shaped component 327 thus closes off a cavity 317, which in this embodiment is empty.

The cavity side wall 318 is closed on itself about an upright funnel axis 319. The cavity side wall 318 is shaped to provide the cavity 317 with an essentially circular cross-section (with the cross-sectional plane perpendicular to the funnel axis 319). The cross-section may be elongated in an alternative embodiment.

The cap-shaped component 327 is self-supporting and made of liquid-impermeable material. Viewed from the cavity 317, the cap-shaped component 327 is concave. It is substantially dome-shaped. A venting aperture 325 is provided at the apex of the dome. Slits 326a,b form liquid-permeable inlet windows allowing liquid to pass from a container interior 314 to the cavity 317. These slits 326a,b extend substantially to a base of the dome.

The cap-shaped component 327 is formed with a flange by which the liquid-treatment section 311 is joined to the container section 310. Specifically, a bond 328 (adhesive or welded joint) is provided between the flange and a rim 329 surrounding an aperture in a section of the funnel side wall 312 forming the bottom of the container section 310. Seams in transitions from the cavity side wall 318 to the funnel side wall 312 are thus between parts of the body of the funnel 8 joined by bonding. These sealed connections prevent untreated liquid in a container interior 314 from bypassing the cavity side wall 318.

In a third implementation of the funnel 8 (FIG. 4), the liquid treatment system further includes a liquid treatment cartridge 430. The liquid treatment cartridge 430 has a liquid-impermeable housing defining a chamber (not shown) arranged to hold one or more liquid treatment media for treating aqueous liquids. The liquid treatment media may include liquid treatment media for the treatment of liquid in a diffusive process, e.g. media removing or adding components to the liquid. In particular, the media may include a liquid treatment medium for the treatment of liquid by sorption, which for present purposes includes ion exchange, adsorption and absorption. The media may include activated carbon. They may include an ion exchange resin, e.g. a cation exchange resin. The cation exchange resin may include cation exchange resin in the hydrogen form. In a particular embodiment, a majority of the ion exchange resin is in the hydrogen form. For more effective use of the available volume, the cation exchange resin may be weakly acidic cation exchange resin. The liquid treatment medium will generally be at least partly in granular form.

The housing of the liquid treatment cartridge 430 includes a beaker-shaped component 431 and a cap 432. It includes liquid-permeable inlet windows 433, provided in the cap 432, and liquid-permeable outlet windows (not shown), provided in a base of the beaker-shaped cartridge housing component 431. Separating the liquid-permeable inlet windows 433 from the outlet windows in flow direction is a circumferential sealing rim 434. The sealing rim 434 is provided where the cap 432 is joined to the beaker-shaped housing component 431. It may be part of a flange of either of these components 431,432.

As illustrated, the beaker-shaped cartridge housing component 431 has a generally circular cross-section, being generally conical in shape. In an alternative embodiment, it may have an elongated cross-section. The cartridge 430 may in particular be a cartridge of the type disclosed more fully in international patent application No. PCT/EP2016/051364 or international patent application No. PCT/EP2016/051361 of 22 Jan. 2016.

A liquid treatment section 411 includes an assembly of parts that is sealingly joined to a container section 410. The assembly includes an axial end wall 420, a cavity side wall 418 and a connecting wall section 435. They surround a cavity 417.

The axial end wall 420 is shaped to have an inner and outer annular ridge 421,422 directed towards the container section 310. The cavity side wall 418 is of the same type as the cavity side walls 218,318 of the first and second implementations described above. It is similarly joined to the axial end wall 420 by a bond 424. The cavity side wall 418 and the axial end wall 420 form a beaker-shaped component.

The cavity side wall 418 is sealingly joined to the connecting wall section 435 at its opposite axial end by a bond 423. To this end, the connecting wall section 435 includes integral inner and outer annular depending wall sections 415,416.

To manufacture the funnel 8 in its third implementation, the assembly of the axial end wall 420, cavity side wall 418 and connecting wall section 435 is manufactured separately from the container section 410. This assembly is subsequently joined to the container section 410 by means of a bond 428 (adhesive or welded joint) that is provided between a flange 436 of the connecting wall section 435 and a rim 429 surrounding an aperture in a section of the funnel side wall 412 forming the bottom of the container section 410.

The connecting wall section 435 has a relatively large aperture extending through it that provides a passage between a container interior 414 and the cavity 417. It is bordered by a sealing surface 437 arranged to engage the sealing rim 434 of the liquid treatment cartridge 430 when the latter is at least partly inserted into the cavity 417. Thus, the connecting wall section 435 additionally defines a cartridge seat.

Since any seams in transitions between the cavity side wall 418 and the funnel side wall 412 are between parts joined by bonding, untreated liquid in the container interior 414 cannot bypass the cavity 417. It is thus also forced to pass through the cavity side wall 418. The liquid treatment medium in the liquid treatment cartridge 430 merely pre-treats the liquid, so that any misalignment between the liquid treatment cartridge 430 and the liquid treatment section 411 that is inseparable from the container section 410 will still not result in potentially contaminated liquid ending up in the jug 1.

The invention is not limited to the embodiments described above, which may be varied within the scope of the accompanying claims.

Although shown as being the exterior side wall of the liquid treatment section 211,311,411, a further wall may surround the cavity side wall 218,318,418 in each embodiment. Such an exterior side wall may be an integral extension of a beaker-shaped component further including the axial end wall 220,320,420, for example. Outlet windows to allow liquid to egress may be provided in either the radially outer section of the axial end wall between the outer annular ridge 222,322,422 and such an exterior side wall, for example. The section of the axial end wall radially inwards of the inner annular ridge 221,321,421, is liquid-impermeable, however, so that the cavity 217,317,417 is closed at the end distal to the container section 210,310,410.

In the embodiments in which the cavity 217,317 is not occupied by a replaceable liquid treatment cartridge 430, in use, it may contain one or more liquid treatment media of the type referred to above in connection with the liquid treatment cartridge 430. Such liquid treatment media may in particular be present in the form of a bed of granular matter.

### LIST OF REFERENCE NUMERALS

1—jug
2—pouring spout
3—handle
4—jug axis
5—lid
6—closure element
7—spout cover
8—funnel
9—ridge
10,210,310—container section
11, 211, 311—liquid treatment section
212,312,412—funnel side wall
213—separating wall section
214,314,414—container interior
215, 315,415—inner annular depending wall section
216, 316,416—outer annular depending wall section
217,317,417—cavity
218,318,418—cavity side wall
219, 319,419—funnel axis
220, 320,420—axial end wall
221, 321,421—inner annular ridge
222, 322,422—outer annular ridge
223, 323,423—upper bond
224, 324,424—lower bond
225,325—venting aperture
226a,b, 326a,b—slits
327—cap-shaped component
328—cap flange bond
329—funnel side wall rim
430—liquid treatment cartridge
431—beaker-shaped cartridge housing component
432—cartridge housing cap
433—cartridge inlet windows
434—sealing rim
435 connecting wall section
436 connecting wall section flange
437—sealing surface

What is claimed is:

1. A liquid treatment device, including:
a container section defining a container for holding liquid to be treated,
the container section including at least part of a body, the body including at least one wall forming at least a bottom of the container,
wherein at least one first liquid-permeable window through the wall forming the bottom of the container is provided; and
a liquid treatment section,
including a cavity surrounded by a cavity side wall forming at least one second liquid-permeable window for treating liquid passing through it,
wherein the cavity side wall is sealingly joined to a liquid-impermeable wall section along the circumference of the cavity side wall and around a liquid path through the cavity and the first liquid-permeable windows at an end of the cavity side wall proximal to the at least one first liquid-permeable window,
wherein the liquid-impermeable wall section is an inseparable part of the body.

2. The liquid treatment device according to claim 1, wherein any seams in transitions between the liquid-impermeable wall section and the at least one wall forming at least the bottom of the container are between parts of the body joined by bonding.

3. The liquid treatment device according to claim 1, wherein the liquid-impermeable wall section adjoins a section of a wall forming the bottom of the container.

4. The liquid treatment device according to claim 1, wherein the liquid treatment section includes an end wall, sealingly joined to the cavity side wall along the circumference of the cavity side wall at an end of the cavity side wall opposite the end joined to the liquid-impermeable wall section, and wherein at least a section of the end wall inwards of where it is joined to the cavity side wall is liquid-impermeable.

5. The liquid treatment device according to claim 1, wherein the at least one first liquid-impermeable window defines at least part of a flow path between an interior of the container and the cavity.

6. The liquid treatment device according to claim 1, wherein the cavity side wall includes at least one layer of sheet material, pleated sheet material, functioning as at least one of the at least one second liquid-permeable window.

7. The liquid treatment device according to claim 6, wherein at least one of the at least one layer of sheet material is a sheet of textile.

8. The liquid treatment device according to claim 7, wherein at least one layer of sheet material is a sheet of functionalised textile.

9. The liquid treatment device according to claim 1, including a further liquid treatment part arranged between an interior of the container and the cavity side wall in a direction of flow.

10. The liquid treatment device according to claim 9, wherein the further liquid treatment part is included in a replaceable liquid treatment cartridge.

11. The liquid treatment device according to claim 1, wherein the at least one first liquid-permeable window includes an aperture bordered along a circumference by a sealing surface for engaging a sealing rim of a replaceable liquid treatment cartridge a sealing surface tapering inwards in a direction of the cavity.

12. A liquid treatment system, including a container for collecting treated liquid and the liquid treatment device according to claim 1, suspendable above a base of the container for collecting treated liquid.

13. The liquid treatment system according to claim 12, wherein the at least one first liquid-permeable window includes an aperture bordered along a circumference by a sealing surface, a sealing surface tapering inwards in a direction of the cavity, further including a replaceable liquid treatment cartridge provided with a circumferential sealing rim for sealingly engaging the sealing surface.

14. A method of manufacturing the liquid treatment device according to claim 1, comprising the steps of: forming a body including at least one of the walls of the container section; and sealingly joining at least one of the liquid-impermeable wall section; and the cavity side wall to the body.

15. The method according to claim 14, wherein at least the cavity side wall is joined to the liquid-impermeable wall section to form an assembly, and wherein the assembly is subsequently joined to a remainder of the body.

16. The liquid treatment device according to claim 2, wherein the liquid-impermeable wall section adjoins a section of a wall forming the bottom of the container, wherein the liquid treatment section includes an end wall, sealingly joined to the cavity side wall along the circumference of the cavity side wall at an end of the cavity side wall opposite the end joined to the liquid-impermeable wall section, and wherein at least a section of the end wall inwards of where it is joined to the cavity side wall is liquid-impermeable.

17. The liquid treatment device according to claim 16, wherein the at least one first liquid-impermeable window defines at least part of a flow path between an interior of the container and the cavity, and wherein the cavity side wall includes at least one layer of sheet material, pleated sheet material, functioning as at least one of the at least one second liquid-permeable window.

18. The liquid treatment device according to claim 17, wherein at least one of the at least one layer of sheet material is a sheet of textile, wherein at least one layer of sheet material is a sheet of functionalised textile.

19. The liquid treatment device according to claim 18, including a further liquid treatment part arranged between an interior of the container and the cavity side wall in a direction of flow, wherein the further liquid treatment part is included in a replaceable liquid treatment cartridge, wherein the at least one first liquid-permeable window includes an aperture bordered along a circumference by a sealing surface for engaging a sealing rim of a replaceable liquid treatment cartridge, a sealing surface tapering inwards in a direction of the cavity.

20. A liquid treatment system, including a container for collecting treated liquid and the liquid treatment device according to claim 19, suspendable above a base of the for collecting treated liquid.
